(19) United States
(12) Patent Application Publication
(10) Pub. No.: US 2025/0290479 A1
(43) Pub. Date: Sep. 18, 2025

(54) FUEL PUMP

(71) Applicant: MITSUBISHI HEAVY INDUSTRIES ENGINE & TURBOCHARGER, LTD., Sagamihara-shi (JP)

(72) Inventor: Hisao OGAWA, Kanagawa (JP)

(73) Assignee: MITSUBISHI HEAVY INDUSTRIES ENGINE & TURBOCHARGER, LTD., Sagamihara-shi (JP)

(21) Appl. No.: 19/227,077

(22) Filed: Jun. 3, 2025

Related U.S. Application Data
(62) Division of application No. 18/565,378, filed on Nov. 29, 2023.

(30) Foreign Application Priority Data
Jul. 6, 2021 (JP) 2021-112245

(51) Int. Cl. F02M 37/04; F04B 53/14

(52) U.S. Cl. CPC F02M 37/043; F04B 53/14

(57) ABSTRACT

A fuel pump according to the present invention includes: a pump head; a plurality of plunger barrel units that are mounted in parallel with the pump head and that include a plurality of pressurization chambers in which a plurality of plungers are movably supported, and in which fuel is pressurized by movement of the plungers; a plurality of discharge valve units disposed in a plurality of fuel discharge channels provided to the pump head so as to each communicate with the plurality of pressurization chambers; a plurality of suction valve units disposed in a plurality of fuel suction channels provided to the pump head so as to each communicate with the plurality of pressurization chambers; a fuel discharge side communication channel by which the plurality of fuel discharge channels are communicated; and a connector that is capable of externally supplying fuel in the fuel discharge side communication channel.

### CROSS-REFERENCE TO RELATED APPLICATIONS

This application is a Divisional of application Ser. No. 18/565,378, filed on Nov. 29, 2023, which is the National Phase under 35 U.S.C. § 371 of International Application No. PCT/JP2022/023810, filed on Jun. 14, 2022, and under 35 U.S.C. § 119(a) to Patent Application No. 2021-112245, filed in Japan on Jul. 6, 2021, all of which are hereby expressly incorporated by reference into the present application.

### TECHNICAL FIELD

The present disclosure relates to a fuel pump applied to an internal combustion engine.

### BACKGROUND ART

For example, a common-rail-type fuel injection device applied to a diesel engine includes a fuel pump, a common rail, and a fuel injector. The fuel pump inhales fuel from a fuel tank, pressurizes the fuel, and supplies the fuel to the common rail as high-pressure fuel. The common rail holds the high-pressure fuel supplied from the fuel pump at a predetermined pressure. The fuel injector injects the high-pressure fuel of the common rail into a combustion chamber of the diesel engine by opening and closing the injector. The fuel pump includes plunger barrels, plungers, suction valves, and discharge valves. In a case where the plunger moves inside the plunger barrel in one direction, the suction valve is opened and the fuel is inhaled into the pressurization chamber. In a case where the plunger moves inside the plunger barrel in the other direction, the fuel in the pressurization chamber is pressurized, and the discharge valve is opened to discharge the high-pressure fuel. Examples of such a fuel pump include a fuel pump described in PTL 1 below.

### CITATION LIST

### Patent Literature

[PTL 1] Japanese Patent No. 5182125

### SUMMARY OF INVENTION

### Technical Problem

In the fuel pump, plungers and plunger barrels are respectively disposed corresponding to a plurality of cams provided on a cam shaft. That is, the fuel pump is configured by disposing plunger units in which a plunger, a suction valve, and a discharge valve are mounted on a plunger barrel at an interval in an axial direction of a cam shaft and connecting the plunger units to each other. For this reason, one plunger unit becomes large, and the plunger barrel has a complicated shape. As a result, there is a problem that processing is difficult and a processing cost increases.

In addition, in each of a plurality of plunger units, each fuel discharge unit is connected to the common rail via each connection pipe. For this reason, a connection structure between the plunger unit and the common rail becomes complicated, and pressure pulsation occurs at different timings in each connection pipe. As a result, this will adversely affect a fuel discharge amount, a fuel discharge pressure, and the like.

The present disclosure has been made to solve the above-described problem, and an object of the present disclosure is to provide a fuel pump that suppresses occurrence of fuel pressure pulsation while simplifying a structure and reducing a processing cost.

### Solution to Problem

In order to achieve the above object, there is provided a fuel pump including: a pump head; a plurality of plunger barrel units in which a plurality of plungers are movably supported, which are provided with a plurality of pressurization chambers for pressurizing fuel by movement of the plungers, and which are mounted in parallel on the pump head; a plurality of discharge valve units that are disposed in a plurality of fuel discharge channels provided in the pump head so as to communicate with the plurality of pressurization chambers; a plurality of suction valve units that are disposed in a plurality of fuel suction channels provided in the pump head so as to communicate with the plurality of pressurization chambers; a fuel-discharge-side communication channel that communicates with the plurality of fuel discharge channels; and a connector that supplies the fuel of the fuel-discharge-side communication channel to outside.

### Advantageous Effects of Invention

According to the fuel pump of the present disclosure, it is possible to simplify a structure and reduce a processing cost, and it is possible to suppress occurrence of fuel pressure pulsation.

### BRIEF DESCRIPTION OF DRAWINGS

FIG. 1 is a schematic configuration diagram illustrating a fuel injection device of the present embodiment.

FIG. 2 is a vertical sectional view illustrating a fuel pump of the present embodiment.

FIG. 3 is a sectional view taken along a III-III line of FIG. 2 illustrating a vertical section of the fuel pump.

FIG. 4 is a sectional view illustrating a connection relationship between a pump head, a plunger barrel unit, a suction valve unit, and a discharge valve unit.

FIG. 5 is a sectional view taken along a V-V line of FIG. 4.

FIG. 6 is a sectional view taken along a VI-VI line of FIG. 4.

FIG. 7 is a sectional view illustrating a modification example of a fuel-suction-side communication channel.

### DESCRIPTION OF EMBODIMENTS

Hereinafter, a preferred embodiment of the present disclosure will be described in detail with reference to the drawings. The present disclosure is not limited by the embodiment, and in a case where there are a plurality of embodiments, the present disclosure also includes a configuration in which the respective embodiments are combined with each other. In addition, components in the embodiment include components that can be easily assumed by those skilled in the art, components that are substantially the same, or components that fall within an equivalent range.

### <Fuel Injection Device>

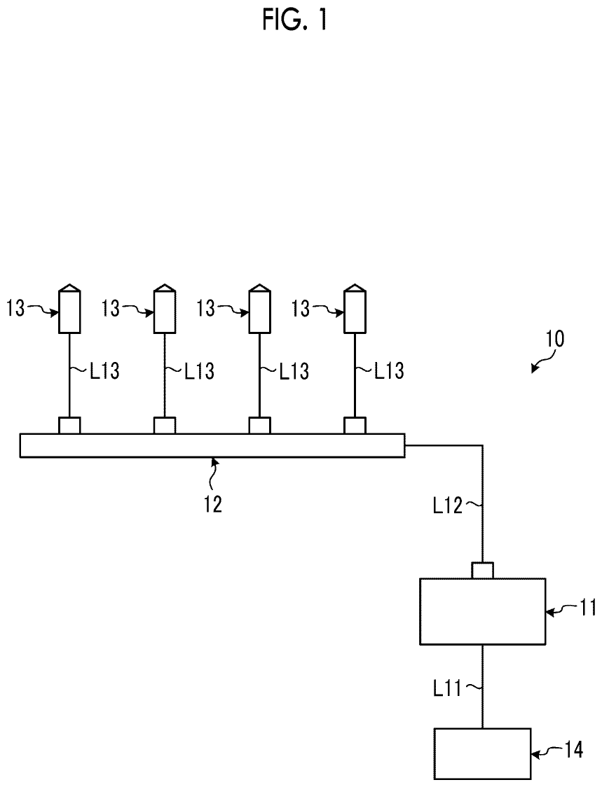

FIG. 1 is a schematic configuration diagram illustrating a fuel injection device of the present embodiment.

As illustrated in FIG. 1, the fuel injection device 10 is mounted on a diesel engine (internal combustion engine). The fuel injection device 10 includes a fuel pump 11, a common rail 12, and a plurality of fuel injectors 13.

A fuel tank 14 is connected to the fuel pump 11 via a fuel line L11. The fuel pump 11 inhales the fuel stored in the fuel tank 14 from the fuel line L11, and pressurizes the fuel to generate high-pressure fuel. The common rail 12 is connected to the fuel pump 11 via a high-pressure fuel line L12. The common rail 12 adjusts the high-pressure fuel supplied from the fuel pump 11 to a predetermined pressure. The fuel injectors 13 are respectively connected to the common rail 12 via a plurality of (in the present embodiment, four) fuel supply lines L13. The fuel injector 13 injects the high-pressure fuel of the common rail 12 into each cylinder (combustion chamber) of the diesel engine by opening and closing the injector.

### <Fuel Pump>

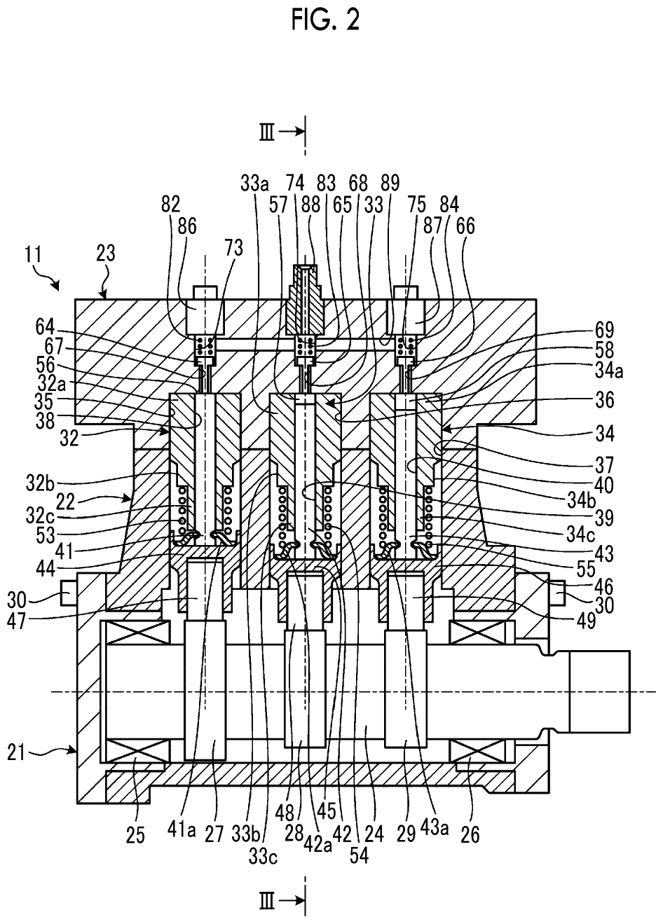

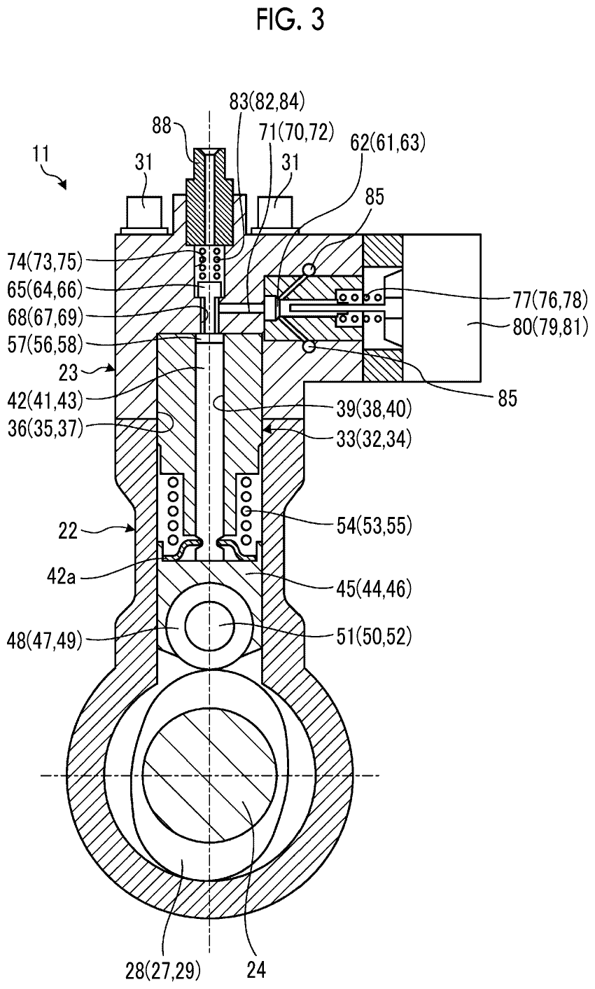

FIG. 2 is a vertical sectional view illustrating the fuel pump of the present embodiment, and FIG. 3 is a sectional view taken along a III-III line of FIG. 2 illustrating a vertical section of the fuel pump. The fuel pump to be described below has a type in which three plungers are disposed. On the other hand, the number of the plungers is not limited thereto.

As illustrated in FIG. 2 and FIG. 3, a housing of the fuel pump 11 is configured by bolt-fastening a retainer 21, a pump casing 22, and a pump head 23. A cam shaft 24 is disposed inside the pump casing 22. Each end portion of the cam shaft 24 in an axial direction is rotatably supported by the retainer 21 by bearings 25 and 26. One end portion of the cam shaft 24 in the axial direction protrudes to the outside of the retainer 21, and a driving force is input from the diesel engine. In the cam shaft 24, a plurality of (in the present embodiment, three) cams 27, 28, and 29 are provided at intervals in the axial direction. The cams 27, 28, and 29 have different phases in a circumferential direction.

The retainer 21 is fastened to the pump casing 22 by a plurality of bolts 30. The plurality of bolts 30 penetrate the retainer 21, and tip portions of the plurality of bolts 30 are screwed to the pump casing 22. The pump head 23 is fastened to the pump casing 22 by a plurality of bolts 31. The plurality of bolts 31 penetrate the pump head 23, and are screwed into the pump casing 22.

Three plunger barrels 32, 33, and 34 are disposed inside the pump casing 22 and the pump head 23. Each of the plunger barrels 32, 33, and 34 has the same configuration. The pump casing 22 and the pump head 23 are provided with three accommodation holes 35, 36, and 37 along a direction orthogonal to the axial direction of the cam shaft 24. The accommodation holes 35, 36, and 37 are formed across the pump casing 22 and the pump head 23. Each of the plunger barrels 32, 33, and 34 is disposed in each of the accommodation holes 35, 36, and 37. That is, the plunger barrels 32, 33, and 34 respectively includes first shaft portions 32a, 33a, and 34a, second shaft portions 32b, 33b, and 34b, and third shaft portions 32c, 33c, and 34c along the axial direction. Outer diameters of the plunger barrels 32, 33, and 34 decrease in order of the first shaft portions 32a, 33a, and 34a, the second shaft portions 32b, 33b, and 34b, and the third shaft portions 32c, 33c, and 34c. In the plunger barrels 32, 33, and 34, the first shaft portions 32a, 33a, and 34a are supported by the accommodation holes 35, 36, and 37.

Support holes 38, 39, and 40 are respectively formed inside the plunger barrels 32, 33, and 34 along the axial direction. The support holes 38, 39, and 40 respectively penetrate the plunger barrels 32, 33, and 34 in the axial direction. In the plunger barrels 32, 33, and 34, plungers 41, 42, and 43 are respectively disposed in the support holes 38, 39, and 40. Each of the plungers 41, 42, and 43 is movably supported along the axial direction in each of the support holes 38, 39, and 40 of the plunger barrels 32, 33, and 34.

Tappets 44, 45, 46 and rollers 47, 48, 49 are respectively disposed between the plungers 41, 42, and 43 and the cams 27, 28, and 29. The rollers 47, 48, and 49 are rotatably supported by the tappets 44, 45, and 46 by using supporting shafts 50, 51, and 52. In the plungers 41, 42, and 43, spring seats 41a, 42a, and 43a are disposed at lower end portions in the axial direction. Compression coil springs 53, 54, and 55 are disposed between the plunger barrels 32, 33, and 34 and the spring seats 41a, 42a, and 43a. The compression coil springs 53, 54, and 55 press the plungers 41, 42, and 43 against the tappets 44, 45, and 46 by an energizing force acting on the spring seats 41a, 42a, and 43a, and the rollers 47, 48, and 49 are pressed against the cams 27, 28, and 29 via the tappets 44, 45, and 46. Outer peripheral surfaces of the rollers 47, 48, and 49 come into contact with outer peripheral surfaces of the cams 27, 28, and 29.

In the plunger barrels 32, 33, and 34, pressurization chambers 56, 57, and 58 are formed in the support holes 38, 39, and 40 on one end portion side in the axial direction. The pressurization chambers 56, 57, and 58 are partitioned by inner peripheral surfaces of the support holes 38, 39, and 40, end surfaces of the plungers 41, 42, and 43 on one end portion side in the axial direction, end surfaces of discharge valves 64, 65, and 66 to be described later, and end surfaces of suction valves 61, 62, and 63 to be described later. The plungers 41, 42, and 43 move the support holes 38, 39, and 40 to the one end portion side in the axial direction, and thus the fuel inhaled into the pressurization chambers 56, 57, and 58 can be pressurized.

In the pump head 23, suction valves 61, 62, and 63 and discharge valves 64, 65, and 66 are disposed. In the pump head 23, fuel channels 67, 68, and 69 that respectively communicate with the support holes 38, 39, and 40 of the plunger barrels 32, 33, and 34 are provided. The fuel channels 67, 68, and 69 are disposed in a straight line with the support holes 38, 39, and 40. One end portions of the fuel channels 67, 68, and 69 communicate with the support holes 38, 39, and 40. One end portions of suction channels (fuel suction channels) 70, 71, and 72 communicate with middle portions of the fuel channels 67, 68, and 69. One end portions of discharge channels (fuel discharge channels) 73, 74, and 75 communicate with the other end portions of the fuel channels 67, 68, and 69. The suction channels 70, 71, and 72 are provided in a direction orthogonal to the fuel channels 67, 68, and 69. The fuel channels 67, 68, and 69 are also used as a part of the fuel suction channels and the fuel discharge channels.

In the suction channels 70, 71, and 72, the suction valves 61, 62, and 63 are disposed. The suction valves 61, 62, and 63 are energized by the compression coil springs 76, 77, and 78 in a direction to open the suction channels 70, 71, and 72, and are operated to close the suction channels 70, 71, and 72 by the actuators 79, 80, and 81. The discharge valves 64, 65, and 66 are disposed in the discharge channels 73, 74, and 75. The discharge valves 64, 65, and 66 are energized by compression coil springs 82, 83, and 84 in a direction to close the discharge channels 73, 74, and 75, and are operated to open the discharge channels 73, 74, and 75 by the fuel pressure. In this case, the pressurization chambers 56, 57, and 58 communicate with the fuel channels 67, 68, and 69 and the suction channels 70, 71, and 72.

The three suction channels 70, 71, and 72 communicate with each other by communication channels (fuel-suction-side communication channels) 85. The fuel line L11 from the fuel tank 14 (both refer to FIG. 1) is connected to the communication channel 85. Plugs 86 and 87 are mounted to the other end portions of the discharge channels 73 and 75, and close the discharge channels 73 and 75. A connector 88 is mounted to the other end portion of the discharge channel 74. In addition, the three discharge channels 73, 74, and 75 are communicated with each other by a communication channel (fuel-discharge-side communication channel) 89. The common rail 12 (both refer to FIG. 1) is connected to the connector 88 via the high-pressure fuel line L12. The communication channel 89 allows the discharge channels 73, 74, and 75 to communicates with each other. On the other hand, the communication channel 89 may be disposed in a linear shape to intersect with the discharge channels 73, 74, and 75, and may directly communicate with the discharge channels 73, 74, and 75. Alternatively, the communication channel 89 may be disposed with an offset in a direction perpendicular to the paper surface of FIG. 2, and may indirectly communicate with the discharge channels 73, 74, and 75.

Therefore, when the cam shaft 24 rotates, a rotational force is converted into a reciprocating force by the cams 27, 28, and 29, and the converted force is transmitted to the rollers 47, 48, and 49 and the tappets 44, 45, and 46. Due to the movement of the rollers 47, 48, and 49 and the tappets 44, 45, and 46, the plungers 41, 42, and 43 reciprocate along the axial direction in the support holes 38, 39, and 40 of the plunger barrels 32, 33, and 34. When the suction valves 61, 62, and 63 open the suction channels 70, 71, and 72 and the plungers 41, 42, and 43 move to the other side in the axial direction (downward side in FIG. 2 and FIG. 3), the low-pressure fuel in the communication channel 85 is inhaled into the pressurization chambers 56, 57, and 58 via the suction channels 70, 71, and 72 and the fuel channels 67, 68, and 69. When the plungers 41, 42, and 43 reach a bottom dead point, in a step in which the plungers 41, 42, and 43 head toward a top dead point, in a case where the actuators 79, 80, and 81 are operated, the suction valves 61, 62, and 63 move against the energizing force of the compression coil springs 76, 77, and 78, and close the suction channels 70, 71, and 72.

In a state where the low-pressure fuel is inhaled into the pressurization chambers 56, 57, and 58, when the plungers 41, 42, and 43 move to one side in the axial direction (upper side in FIG. 2 and FIG. 3), before the actuators 79, 80, and 81 are operated, the low-pressure fuel is returned from the suction channels 70, 71, and 72 to the communication channel 85 via the suction valves 61, 62, and 63. After the actuators 79, 80, and 81 are operated, the low-pressure fuel is closed by the suction valves 61, 62, and 63, and volumes of the pressurization chambers 56, 57, and 58 are reduced. Thus, the low-pressure fuel in the pressurization chambers 56, 57, and 58 is pressurized. When the low-pressure fuel in the pressurization chambers 56, 57, and 58 is pressurized to a predetermined pressure, the discharge valves 64, 65, and 66 move against the energizing force of the compression coil springs 82, 83, and 84 and the pressure received from the common rail 12, and open the discharge channels 73, 74, and 75. Then, the high-pressure fuel in the pressurization chambers 56, 57, and 58 is discharged from the fuel channels 67, 68, and 69 to the discharge channels 73, 74, and 75. In addition, the high-pressure fuel in the discharge channels 73, 74, and 75 is joined at the communication channel 89, and is discharged from the connector 88 to the high-pressure fuel line L12 (refer to FIG. 1). Thereafter, when the plungers 41, 42, and 43 reach the top dead point, discharge of the high-pressure fuel is ended. When the plungers 41, 42, and 43 start to move to the other side in the axial direction, the volumes of the pressurization chambers 56, 57, and 58 are increased, and thus, the pressure in the pressurization chambers 56, 57, and 58 decreases. The discharge valves 64, 65, and 66 move due to the energizing force of the compression coil springs 82, 83, and 84 and the pressure received from the common rail 12, and close the discharge channels 73, 74, and 75.

### <Implementation of Fuel Pump as Units>

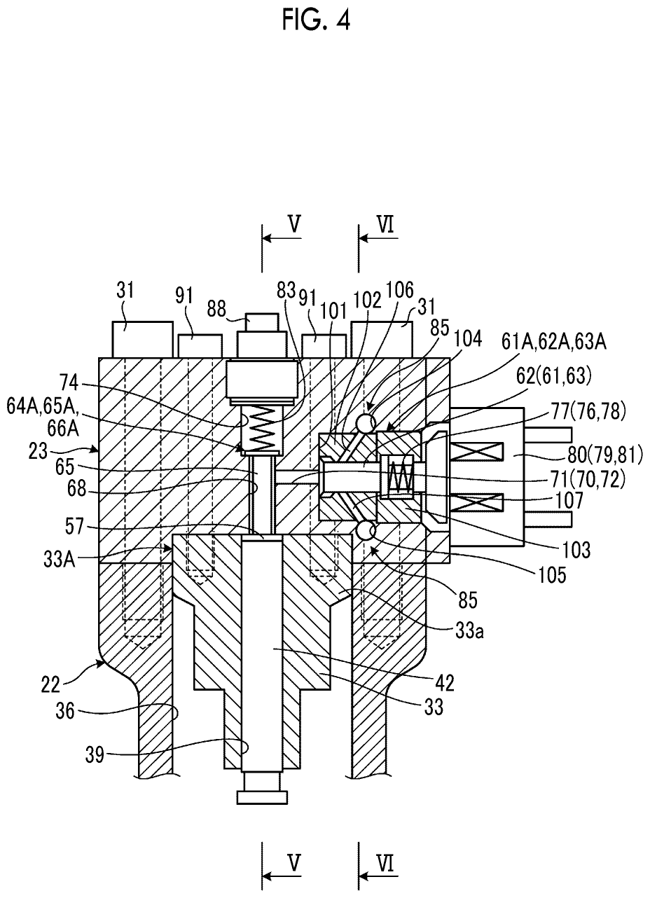

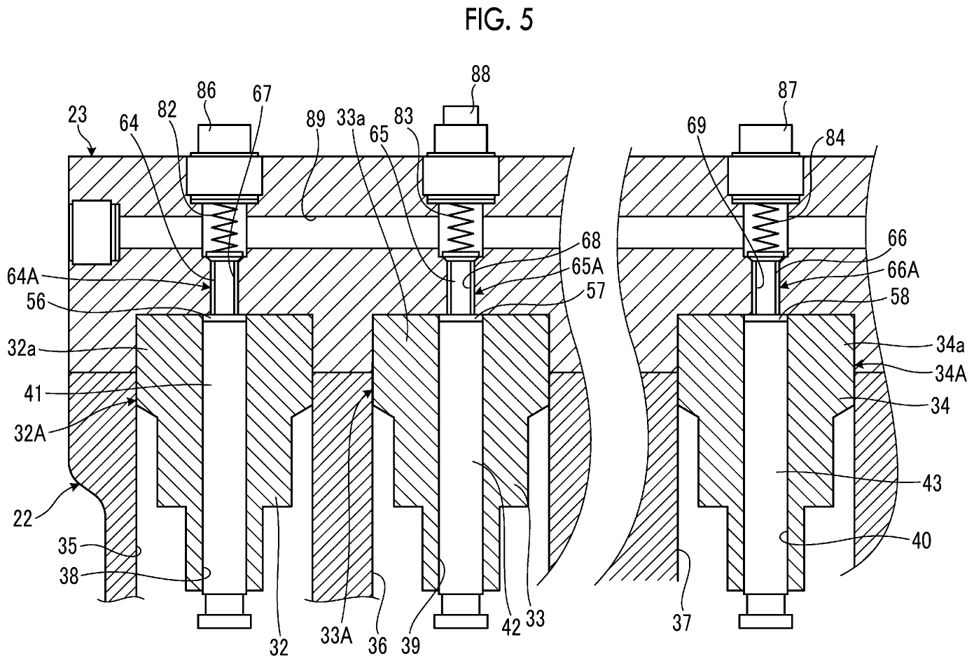

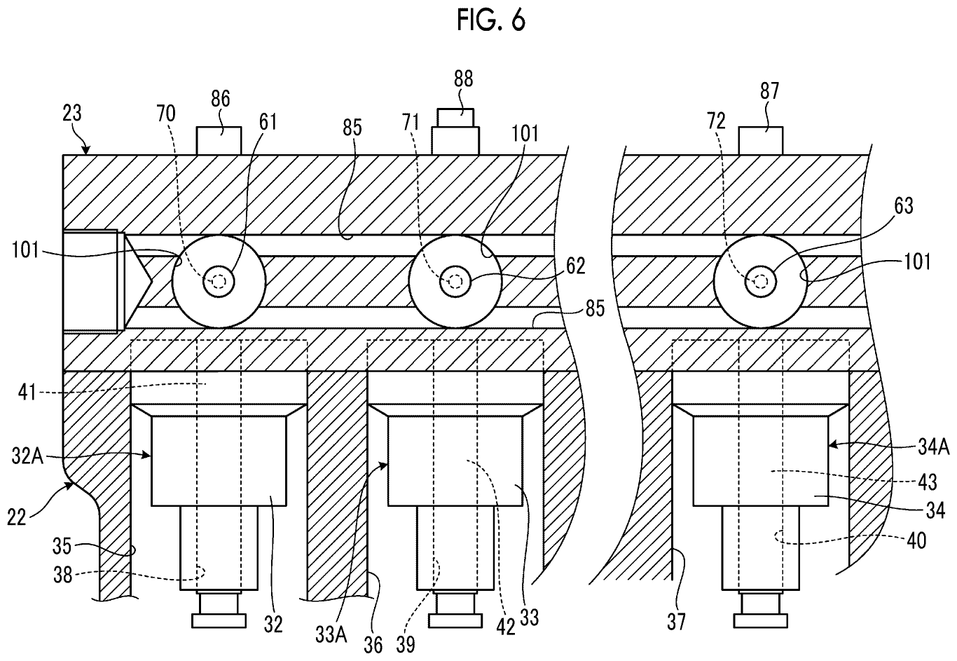

FIG. 4 is a sectional view illustrating a connection relationship between a pump head, a plunger barrel unit, a suction valve unit, and a discharge valve unit, FIG. 5 is a sectional view taken along a V-V line of FIG. 4, and FIG. 6 is a sectional view taken along a VI-VI line of FIG. 4.

As illustrated in FIG. 4 to FIG. 6, the pump head 23 is fastened to the pump casing 22 by bolts 31. The pump casing 22 and the pump head 23 are provided with accommodation holes 35, 36, and 37 inside, and the plunger barrels 32, 33, and 34 are supported by the accommodation holes 35, 36, and 37. That is, in the plunger barrels 32, 33, and 34, first shaft portions (convex portions) 32a, 33a, and 34a are accommodated in the accommodation holes 35, 36, and 37. One end portion sides of the plunger barrels 32, 33, and 34 in the axial direction are fastened to the pump head 23. A plurality of bolts 91 penetrate the pump head 23, and tip portions of the bolts 91 are screwed to the first shaft portions 32a, 33a, and 34a of the plunger barrels 32, 33, and 34.

Support holes 38, 39, and 40 are formed in the plunger barrels 32, 33, and 34, and the plungers 41, 42, and 43 are movably supported by the support holes 38, 39, and 40. The pump head 23 is provided with fuel channels 67, 68, and 69 that communicate with the support holes 38, 39, and 40 in a straight line. The fuel channels 67, 68, and 69 communicate with the suction channels 70, 71, and 72 so as to intersect (orthogonal) with the suction channels 70, 71, and 72, and communicate with the discharge channels 73, 74, and 75 in a straight line. The suction valves 61, 62, and 63 are disposed in the suction channels 70, 71, and 72, and the discharge valves 64, 65, and 66 are disposed in the fuel channels 67, 68, and 69 and the discharge channels 73, 74, and 75.

In the present embodiment, the plunger barrels 32, 33, and 34, the suction valves 61, 62, and 63, and the discharge valves 64, 65, and 66 are respectively implemented as units, and the units are respectively mounted on the pump head 23. The plunger barrel units 32A, 33A, and 34A are mounted in parallel on the pump head 23. The suction valve units 61A, 62A, and 63A are respectively disposed in the suction channels 70, 71, and 72. The discharge valve units 64A, 65A, and 66A are respectively disposed in the fuel channels 67, 68, and 69 and in the discharge channels 73, 74, and 75.

As illustrated in FIG. 4, the plunger barrel units 32A, 33A, and 34A are configured by the plunger barrels 32, 33, and 34 and the plungers 41, 42, and 43. Here, the plunger barrel units 32A, 33A, and 34A are not limited to the configuration, and may include, for example, the tappets 44, 45, and 46, the rollers 47, 48, and 49, the supporting shafts 50, 51, and 52, and the compression coil springs 53, 54, and 55, and the like.

Next, the suction valve units 61A, 62A, and 63A will be described. The suction valve units 61A, 62A, and 63A have the same configuration, and thus only the suction valve unit 62A will be described.

As illustrated in FIG. 4, the pump head 23 is provided with the fuel channel 68, the suction channel 71, and the discharge channel 74. The support hole 39, the fuel channel 68, and the discharge channel 74 are disposed in a straight line, and communicate with each other. The suction channel 71 is disposed to be orthogonal to the fuel channel 68, and one end portion of the suction channel 71 communicates with the fuel channel 68. In the pump head 23, an accommodation recess portion 101 is formed to communicate with the other end portion of the suction channel 71. A suction valve casing 102 and a fixing member 103 are disposed in the accommodation recess portion 101. The suction valve 62 is movably supported in the axial direction inside the suction valve casing 102, and the suction valve casing 102 is disposed on the suction channel 71 side in the accommodation recess 101. The fixing member 103 is disposed in contact with the suction valve casing 102 on the opening side of the accommodation recess portion 101, and is fixed to the pump head 23. Thus, the suction valve casing 102 is positioned and is fixed to the pump head 23.

The compression coil spring 77 is disposed between the suction valve 62 and the suction valve casing 102. The suction valve 62 is supported by the energizing force of the compression coil spring 77 in a direction to open the suction channel 71. In addition, the suction valve 62 is movable so as to close the suction channel 71 by the actuator 80. Further, in the pump head 23, communication channels 104 and 105 are formed on both sides of the suction valve 62 in a radial direction along a direction intersecting with the suction channel 71. The communication channels 104 and 105 communicate with the suction channel 71 via openings 106 and 107 formed in the suction valve casing 102. The two communication channels 85 are configured with the communication channels 104 and 105 and the openings 106 and 107. The two communication channels 85 are disposed to be shifted with respect to center positions of the suction channels 70, 71, and 72 (the suction valves 61, 62, and 63) on one side and the other side in the radial direction, and the suction channels 70, 71, and 72 can be communicated with each other.

The suction valve units 61A, 62A, and 63A are configured with the suction valve casing 102, the fixing member 103, and the like, in addition to the suction valves 61, 62, and 63, the compression coil springs 76, 77, and 78, and the actuators 79, 80, and 81. Here, the suction valve units 61A, 62A, and 63A are not limited to the configuration, and for example, the actuators 79, 80, and 81 may be separate units.

In addition, as illustrated in FIG. 5, the fuel channels 67, 68, and 69 communicate with the discharge channels 73, 74, and 75, and the discharge valves 64, 65, and 66 are disposed across the fuel channels 67, 68, and 69 and the discharge channels 73, 74, and 75. The compression coil springs 82 and 84 are disposed between the discharge valves 64 and 66 and the plugs 86 and 87, and the compression coil spring 83 is disposed between the discharge valve 65 and the connector 88. The discharge valves 64, 65, and 66 are energized and supported by the compression coil springs 82, 83, and 84 in a direction to close the discharge channels 73, 74, and 75. When the fuel pressure in the pressurization chambers 56, 57, and 58 exceeds the discharge pressure, the discharge channels 73, 74 and 75 are opened.

The three discharge channels 73, 74, and 75 are communicated with each other by the communication channel 89. In this case, the communication channel 89 has a linear shape along a direction orthogonal to the fuel channels 67, 68, and 69 and the discharge channels 73, 74, and 75. The communication channel 89 allows the discharge channel 73, the discharge channel 74, and the discharge channel 75 to communicate with each other. In addition, the connector 88 is provided at an end portion of the discharge channel 74. The connector 88 may be provided not at the discharge channel 74 but at the discharge channel 73 or the discharge channel 75, or may be provided so as to communicate with the communication channel 89.

The discharge valve units 64A, 65A, and 66A are configured with the discharge valves 64, 65, and 66 and the compression coil springs 82, 83, and 84. Here, the discharge valve units 64A, 65A, and 66A are not limited to the configuration.

In the fuel pump 11, the plurality of plunger barrel units 32A, 33A, and 34A, the plurality of suction valve units 61A, 62A, and 63A, and the plurality of discharge valve units 64A, 65A, and 66A are independently mounted on the pump head 23. Therefore, structures of the pump head 23, the plunger barrel units 32A, 33A, and 34A, the suction valve units 61A, 62A, and 63A, and the discharge valve units 64A, 65A, and 66A can be simplified. In addition, the discharge channels 73, 74, and 75 communicate with each other via the communication channel 85 of the pump head 23. Thereby, discharge pressure pulsation of the high-pressure fuel discharged from the discharge channels 73, 74, and 75 to the communication channel 85 is relieved by the communication channel 85. Therefore, the pressure pulsation of the fuel discharged from the connector 88 to the high-pressure fuel line L12 is suppressed.

### <Modification Example of Pump Head>

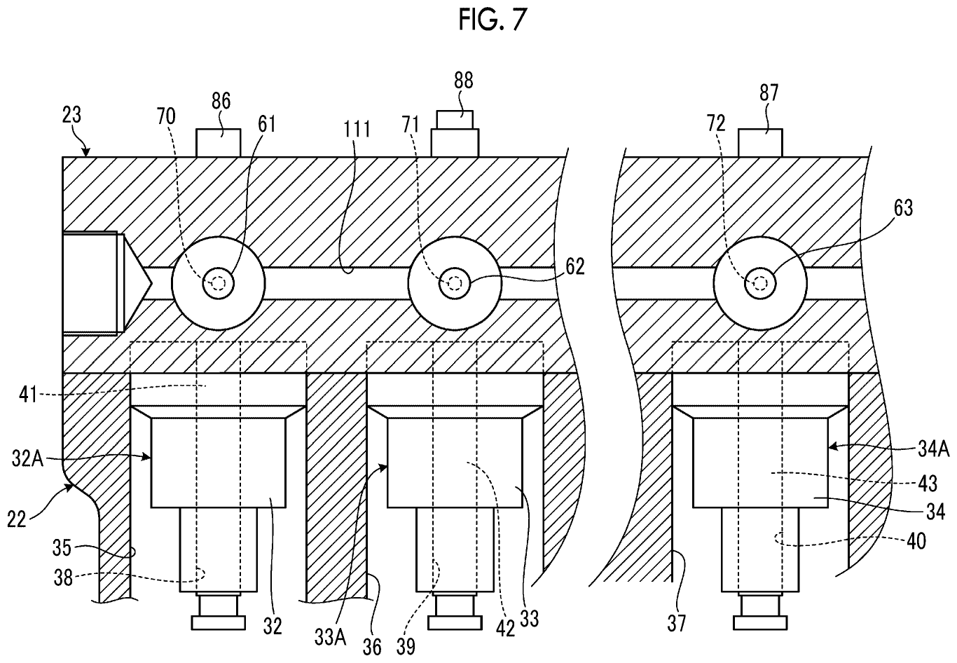

FIG. 7 is a sectional view illustrating a modification example of the fuel-suction-side communication channel.

In a modification example of the present embodiment, as illustrated in FIG. 7, the suction channels 70, 71, and 72 are disposed in the suction valves 61, 62, and 63. The suction valves 61, 62, and 63 are energized by the compression coil springs 76, 77, and 78 (refer to FIG. 4) in a direction to close the suction channels 70, 71, and 72. The three suction channels 70, 71, and 72 communicate with each other via a communication channel (fuel-suction-side communication channel) 111. The communication channel 111 is disposed at center positions of the suction channels 70, 71, and 72 (the suction valves 61, 62, and 63), and the suction channels 70, 71, and 72 can be communicated with each other.

### Actions and Effects of Present Embodiment

According to a first aspect, there is provided a fuel pump including: a pump head 23; a plurality of plunger barrel units 32A, 33A, and 34A in which a plurality of plungers 41, 42, and 43 are movably supported, which are provided with a plurality of pressurization chambers 56, 57, and 58 for pressurizing fuel by movement of the plungers 41, 42, and 43, and which are mounted in parallel on the pump head 23; a plurality of discharge valve units 64A, 65A, and 66A that are disposed in a plurality of discharge channels 73, 74, and 75 provided in the pump head 23 so as to communicate with the plurality of pressurization chambers 56, 57, and 58; a plurality of suction valve units 61A, 62A, and 63A that are disposed in a plurality of suction channels 70, 71, and 72 provided in the pump head 23 so as to communicate with the plurality of pressurization chambers 56, 57, and 58; a communication channel (fuel-discharge-side communication channel) 89 that communicates with the plurality of discharge channels 73, 74, and 75; and a connector 88 that supplies the fuel of the communication channel 89 to outside.

With the fuel pump according to the first aspect, the plunger barrel units 32A, 33A, and 34A, the suction valve units 61A, 62A, and 63A, and the discharge valve units 64A, 65A, and 66A are independently mounted on the pump head 23. Therefore, the structures of the pump head 23, the plunger barrel units 32A, 33A, and 34A, the suction valve units 61A, 62A, and 63A, and the discharge valve units 64A, 65A, and 66A can be simplified, and thus a processing cost can be reduced. In addition, by disposing the plurality of plunger barrel units 32A, 33A, and 34A in parallel with respect to the pump head 23, it is possible to easily change the design according to the number of the plunger barrel units 32A, 33A, and 34A. Further, the discharge channels 73, 74, and 75 communicate with each other via the communication channel 85 of the pump head 23. Thereby, discharge pressure pulsation of the high-pressure fuel discharged from the discharge channels 73, 74, and 75 to the communication channel 85 is relieved by the communication channel 85. Therefore, the pressure pulsation of the fuel discharged from the connector 88 to the high-pressure fuel line L12 can be suppressed.

In the fuel pump according to a second aspect, the plurality of discharge channels 73, 74, and 75 are disposed in a straight line with respect to a plurality of support holes 38, 39, and 40 in which the plurality of plungers 41, 42, and 43 are movably supported, the communication channel 89 communicates with the plurality of discharge channels 73, 74, and 75 so as to intersect with the plurality of discharge channels 73, 74, and 75, and the plurality of suction channels 70, 71, and 72 communicate with the plurality of discharge channels 73, 74, and 75 so as to intersect with the plurality of discharge channels 73, 74, and 75 between the plurality of pressurization chambers 56, 57, and 58 and the communication channel 89. Thereby, only the fuel channels 67, 68, and 69 communicate with the pressurization chambers 56, 57, and 58, and thus inner diameters of the support holes 38, 39, and 40 of the pressurization chambers 56, 57, and 58 can be reduced.

In the fuel pump according to a third aspect, the connector 88 is provided at any one of the plurality of discharge channels 73, 74, and 75. Thereby, the plugs of the discharge channels 73, 74, and 75 can also be used as the connector 88, and thus the structure can be simplified.

In the fuel pump according to a fourth aspect, the plunger barrel units 32A, 33A, and 34A are provided with first shaft portions (convex portions) 32a, 33a, and 34a on one end portion side in an axial direction, the pump head 23 is provided with the accommodation holes (recess portions) 35, 36, and 37, and the first shaft portions 32a, 33a, and 34a are fitted into the accommodation holes 35, 36, and 37 for positioning. Thereby, the plunger barrel units 32A, 33A, and 34A can be mounted on the pump head 23 with high accuracy.

In the fuel pump according to a fifth aspect, a pair of communication channels (fuel-suction-side communication channels) 85 communicating with the plurality of suction channels 70, 71, and 72 are provided on both sides of the suction channels 70, 71, and 72 in the radial direction. Thereby, the fuel is supplied from the pair of communication channels 85 to the suction channels 70, 71, and 72. Therefore, even in a case where air is mixed with the fuel, the mixed air is quickly discharged to the pressurization chambers 56, 57, and 58, and thus it possible to suppress fluctuations in the fuel discharge amount.

In the above-described embodiment, the support holes 38, 39, and 40 have the same diameter in the axial direction, and one end portions of the support holes 38, 39, and 40 communicate with the fuel channels 67, 68, and 69. On the other hand, the present invention is not limited to the configuration. For example, the support hole may be configured with a main body hole having the same diameter as the support holes 38, 39, and 40 and a small diameter portion having a diameter smaller than the diameter of the support holes 38, 39, and 40, and the small diameter portion may communicate with the fuel channels 67, 68, and 69. In this case, the plungers 41, 42, and 43 are movably supported only by the main body holes.

Further, a form of the fuel injection device 10 and a form of the fuel pump 11 are not limited to the above-described embodiment. For example, the number of the common rails 12 and the fuel injectors 13, the connection position of the fuel pump 11, the number of the plungers 41, 42, and 43, and the plunger barrels 32, 33, and 34 may be appropriately set.

### REFERENCE SIGNS LIST

10: fuel injection device
11: fuel pump
12: common rail
13: fuel injector
14: fuel tank
21: retainer
22: pump casing
23: pump head
24: cam shaft
25, 26: bearing
27, 28, 29: cam
30, 31: bolt
32, 33, 34: plunger barrel
35, 36, 37: accommodation hole (recess portion)
38, 39, 40: support hole
41, 42, 43: plunger
44, 45, 46: tappet
47, 48, 49: roller
50, 51, 52: supporting shaft
53, 54, 55: compression coil spring
61, 62, 63: suction valve
64, 65, 66: discharge valve
67, 68, 69: fuel channel
70, 71, 72: suction channel
73, 74, 75: discharge channel
76, 77, 78: compression coil spring
79, 80, 81: actuator
82, 83, 84: compression coil spring
85: communication channel (fuel-suction-side communication channel)
86, 87: plug
88: connector
89: communication channel (fuel-discharge-side communication channel)
91: bolt
101: accommodation recess portion
102: suction valve casing
103: fixing member
104, 105: communication channel
106, 107: opening
111: fuel line
112: high-pressure fuel line
113: fuel supply line

1. A fuel pump comprising:
a pump head;
a plurality of plunger barrel units in which a plurality of plungers are movably supported, which are provided with a plurality of pressurization chambers for pressurizing fuel by movement of the plungers, and which are mounted in parallel on the pump head;
a plurality of discharge valve units that are disposed in a plurality of fuel discharge channels provided in the pump head so as to communicate with the plurality of pressurization chambers;
a plurality of suction valve units that are disposed in a plurality of fuel suction channels provided in the pump head so as to communicate with the plurality of pressurization chambers;
a fuel-discharge-side communication channel that communicates with the plurality of fuel discharge channels; and
a connector that supplies the fuel of the fuel-discharge-side communication channel to outside,
wherein fuel-suction-side communication channels communicating with the plurality of fuel suction channels are provided on both sides of the fuel suction channel in a radial direction.
